(19) United States
(12) Patent Application Publication
(10) Pub. No.: US 2023/0078437 A1
(43) Pub. Date: Mar. 16, 2023

(54) Milk Powder Containing Maltopentaose Trehalose instead of Maltodextrin and Preparation Method Thereof

(71) Applicant: Jiangnan University, Wuxi (CN)

(72) Inventors: Bo JIANG, Wuxi (CN); Ying PAN, Wuxi (CN); Tao ZHANG, Wuxi (CN); Jingjing CHEN, Wuxi (CN)

(21) Appl. No.: 17/990,793

(22) Filed: Nov. 21, 2022

Related U.S. Application Data
(63) Continuation of application No. PCT/CN2022/099449, filed on Jun. 17, 2022.

(30) Foreign Application Priority Data
Jul. 8, 2021 (CN) 2021107816612

(51) Int. Cl. A23C 9/156; A23L 33/00; A23C 9/158; A23C 9/152; A23C 1/04; A23L 33/115; A23L 33/125; A23L 33/16; A23L 33/155; A23L 33/19

(52) U.S. Cl. CPC A23C 9/156; A23L 33/40; A23C 9/158; A23C 9/1522; A23C 9/1528; A23C 1/04; A23L 33/115; A23L 33/125; A23L 33/16; A23L 33/155; A23L 33/19; A23V 2002/00

(57) ABSTRACT

The present disclosure discloses a milk powder containing maltopentaose trehalose instead of maltodextrin and a preparation method thereof, and belongs to the field of processing of dairy products. In the present disclosure, a formula milk powder containing maltopentaose trehalose instead of maltodextrin includes the following raw materials in parts by mass: 85-90 parts of fresh milk, 1-2 parts of maltopentaose trehalose, 5-10 parts of vegetable oil, 1-2 parts of a desalted whey powder, 1.5-3 parts of a concentrated whey protein powder, 0.5-0.8 parts of lactose, 0.05-0.1 parts of a multivitamin, and 0.05-0.1 parts of a complex mineral. Differences in physical and chemical properties of products due to a nonuniform polymerization degree of maltodextrin are reduced, and the problem that a Maillard reaction is likely to be induced when the maltodextrin is mixed with an amino acid or protein is solved.

### TECHNICAL FIELD

The present disclosure relates to a milk powder containing maltopentaose trehalose instead of maltodextrin and a preparation method thereof, and belongs to the field of processing of dairy products.

### BACKGROUND

Maltodextrin with a low DE (dextrose equivalent) value has functional properties such as swelling, crystallization prevention, gelling, and dispersion promotion. Thus, the maltodextrin has been widely used in various processed foods, such as formula milk powders for infants, sports drinks, and energy supplements. Although the maltodextrin has low cost and wide application, some unsolved bottleneck problems still exist.

As a mixture with a nonuniform polymerization degree, the maltodextrin cannot maintain stable physical and chemical effects. In addition, since the DE value is an average value of a mixture, the maltodextrin with the same DE value has large differences in physical and chemical properties. In addition, the maltodextrin has a reducing end. Therefore, when the maltodextrin is mixed with an amino acid or protein, a Maillard reaction is likely to be induced. Due to a brown color formed by a strong browning reaction and the occurrence of the Maillard reaction, the quality of products containing such maltodextrin is reduced.

### SUMMARY

### Technical Problems

As a mixture with a nonuniform polymerization degree, maltodextrin cannot maintain stable physical and chemical effects. The maltodextrin with the same DE value has large differences in physical and chemical properties. In addition, when the maltodextrin is mixed with an amino acid or protein, a Maillard reaction is likely to be induced.

### Technical Solutions

In order to solve at least one of the above problems, the present disclosure provides a formula milk powder containing maltopentaose trehalose instead of maltodextrin. A browning problem of milk powders in a storage process is solved, and unstable problems such as agglomeration and adhesion of milk powders after storage for a long term are solved. In the present disclosure, the maltopentaose trehalose is obtained by using β-cyclodextrin as a raw material, obtaining straight-chain maltodextrin through ring-opening conversion with a cyclodextrin degrading enzyme based on the principle of a double enzyme cascade reaction, and then reversing a glucose reducing end with a maltooligosaccharide trehalose synthetase to realize non-reducing transformation. The formula milk powder is prepared by using the maltopentaose trehalose instead of maltodextrin, and application defects of the maltodextrin are made up for to a large extent.

A first objective of the present disclosure is to provide a formula milk powder containing maltopentaose trehalose instead of maltodextrin. The formula milk powder includes the following raw materials in parts by mass: 85-90 parts of fresh milk, 1-2 parts of maltopentaose trehalose, 5-10 parts of vegetable oil, 1-2 parts of a desalted whey powder, 1.5-3 parts of a concentrated whey protein powder, 0.5-0.8 parts of lactose, 0.05-0.1 parts of a multivitamin, and 0.05-0.1 parts of a complex mineral.

In an embodiment of the present disclosure, with reference to the patent CN 111304270 A, the maltopentaose trehalose is obtained by hydrolyzing β-cyclodextrin as a substrate with a cyclodextrin degrading enzyme into maltoheptaose, converting an α-1,4-glycosidic bond into an α-1,1-glycosidic bond with a maltose trehalose synthetase, and then conducting refining. The refining includes subjecting a product obtained after an enzymatic conversion reaction to enzyme deactivation, decolorization, and separation and purification through Na-type cation exchange resin, collecting a solution with a purity of greater than 95%, and then conducting freeze-drying. During the separation and purification, a chromatography column with a specification of 1.6 cm*100 cm is used, the resin is filled to 60%-70% of a height of the chromatography column, and the solution is collected at a temperature of 55-60° C., a loading volume of 5-10 mL, and a flow rate of 0.5-0.8 mL/min. The freeze-drying includes freezing at −50° C. to −60° C. for 10-30 h. The enzyme deactivation is conducted by boiling for 10 min. The decolorization is conducted by using activated carbon.

In an embodiment of the present disclosure, a method for preparing the maltopentaose trehalose includes the following steps:

adding β-cyclodextrin to water or a buffer solution to obtain a cyclodextrin solution with a concentration of 10-30 g/L; then, adding a cyclodextrin degrading enzyme and a maltooligosaccharide trehalose synthetase to the cyclodextrin at an amount of 0.5-5 U/g_{cyclodextrin} and 10-100 U/g_{cyclodextrin} respectively for a reaction at a temperature of 25-65° C. and a pH of 5.0-8.5 for 20-40 min to obtain a maltodextrin-containing reaction solution; and finally, refining the maltodextrin-containing reaction solution to obtain the maltopentaose trehalose (non-reducing maltodextrin).

In an embodiment of the present disclosure, the vegetable oil includes one or more of corn oil, palm oil, sunflower seed oil, soybean oil, rapeseed oil, and coconut oil.

In an embodiment of the present disclosure, the multivitamin includes the components of a vitamin A, a vitamin C, a vitamin D, a vitamin E, a vitamin 131, a vitamin B2, a vitamin B6, a vitamin B12, a vitamin K1, folic acid, and pantothenic acid at a mass ratio of 1:(3-5):(0.002-0.005):(30-32):(5-8):(25-27):(18-20):(0.001-0.002):(0.008-0.01):(1-5):(10-12).

In an embodiment of the present disclosure, the complex mineral includes the components of calcium carbonate, potassium chloride, magnesium chloride, zinc sulfate, and ferric pyrosulfate at a mass ratio of 1:(1-2):(10-15):(1.6-2):(2-4).

A second objective of the present disclosure is to provide a method for preparing the formula milk powder described in the present disclosure. The method includes the following steps:

(1) adding the maltopentaose trehalose, the desalted whey powder, the concentrated whey protein powder, and the lactose to the fresh milk for dissolution, adding the vegetable oil for high-speed shearing homogenization, and then conducting filtration to obtain a mixed solution;

(2) subjecting the mixed solution obtained in step (1) to high-pressure homogenization at 15-20 MPa to obtain a mixed solution after high-pressure homogenization;

(3) concentrating the mixed solution obtained in step (2) to a solid content of 50%-55%, and conducting spray drying to obtain a powdery base powder; and

(4) adding the multivitamin and the complex mineral to the powdery base powder obtained in step (3) for uniform mixing to obtain the formula milk powder.

In an embodiment of the present disclosure, in step (1), the dissolution is conducted by stirring at 40-50° C. and 300-500 rpm until complete dissolution.

In an embodiment of the present disclosure, in step (1), the high-speed shearing homogenization is conducted at a shearing speed of 3,000-5,000 rpm for 1-2 min.

In an embodiment of the present disclosure, in step (1), the filtration is conducted to remove an insoluble substance through two layers of gauze.

In an embodiment of the present disclosure, in step (2), the high-pressure homogenization is conducted at a temperature of 30-40° C. for 5-8 min.

In an embodiment of the present disclosure, in step (3), the spray drying is conducted at an inlet air temperature of 160-180° C. and an outlet air temperature of 85-90° C.

### Beneficial Effects

(1) According to the present disclosure, differences in physical and chemical properties of products due to a nonuniform polymerization degree of maltodextrin are reduced, and the problem that a Maillard reaction is likely to be induced when the maltodextrin is mixed with an amino acid or protein is solved. Meanwhile, properties of the maltodextrin as a drying auxiliary agent are retained, and the storage stability of a powder at high humidity is ensured. In addition, the effect of adding a large amount of the maltodextrin to the milk powder can be achieved by adding a small amount of the maltopentaose trehalose to the milk powder.

(2) In the present disclosure, a wet process is used for production, so that the uniformity of various components in a product is achieved. Moreover, due to dry mixing of nutrient elements, heat-sensitive nutrient compositions are ensured. In addition, after the maltopentaose trehalose is added, sensory properties of the formula milk powder cannot be affected, and the obtained milk powder has a rich milk flavor and a smooth and dense taste.

(3) In the present disclosure, the method for preparing the formula milk powder by adding the maltopentaose trehalose has the advantages of simple production process, low production cost, and high operability, and is conducive to stable production in batches.

(4) After the formula milk powder of the present disclosure is stored at 22° C. and a relative humidity of 54% RH for 180 days, an L* value is still maintained at 93-94, a b* value is still maintained at 6.5-7.5, and the milk powder has great surface morphology, which is in a smooth spherical shape. The milk powder has a solubility of greater than 88% in water, a glass transition temperature of 64-66° C., and high thermal stability. In addition, the use amount of the maltopentaose trehalose can be reduced to one fifth of the use amount of the maltodextrin to achieve the same effect.

### BRIEF DESCRIPTION OF FIGURES

FIG. 1 shows changes of an L* value at different storage times in Example 1 and Comparative Examples 1 and 2.

FIG. 2 shows changes of a b* value at different storage times in Example 1 and Comparative Examples 1 and 2.

FIG. 3 shows the surface morphology after storage at 23% RH for 90 days in Example 1 and Comparative Examples 1 and 2.

FIG. 4 shows the solubility at different storage times in Example 1 and Comparative Examples 1 and 2.

FIG. 5 shows the glass transition temperature at different storage times in Example 1 and Comparative Examples 1 and 2.

### DETAILED DESCRIPTION

The preferred examples of the present disclosure are illustrated below. It should be understood that the examples are intended to better explain the present disclosure, rather than to limit the present disclosure.

With reference to the patent CN 111304270 A, a method for preparing maltopentaose trehalose used in Example 1 and Comparative Example 2 specifically includes the following steps:

adding β-cyclodextrin to water to obtain a cyclodextrin solution with a concentration of 20 g/L; adding 5 U/g_{cyclodextrin} of a cyclodextrin degrading enzyme and 30 U/g_{cyclodextrin} of a maltooligosaccharide trehalose synthetase to the cyclodextrin solution for a reaction at 35° C. and a pH of 7.5 for 30 min to obtain a maltodextrin-containing reaction solution; subjecting the reaction solution to enzyme deactivation (by boiling for 10 min) and decolorization (with activated carbon); using a chromatography column with a specification of 1.6 cm*100 cm, where Na-type cation exchange resin is filled to 70% of a height of the chromatography column; collecting a solution with a purity of greater than 95% at a temperature of 60° C., a loading volume of 10 mL, and a flow rate of 0.5 mL/min; and then conducting freeze-drying at −60° C. for 24 h to obtain the maltopentaose trehalose (non-reducing maltodextrin).

Test Methods:

Changes in the color, surface morphology, solubility, and glass transition temperature of an obtained formula milk powder at 22° C. and a relative humidity of 23% RH and 54% RH (the temperature of 22° C. refers to an environmental condition, and the two humidity values refer to common RH conditions in processing, transportation, and storage of a milk powder) are recorded.

Specific detection methods are as follows.

(1) Color

An L* value and a b* value were measured by using a high-precision spectrophotometer. The L* value refers to the brightness, and a higher value indicates higher brightness. The b* value refers to a yellow color or blue color of an object, and a positive value indicates a yellow color.

(2) Surface Morphology

The surface morphology of a powder was observed by using a scanning electron microscope.

(3) Solubility

5 g of a powder was added to 95 g of water at room temperature (22° C.) for uniform mixing and stirring at a speed of 500 rpm for 1 h. After the mixing, a solution was subjected to standing for 15 min. Then, the solution was slightly stirred, added to two centrifuge tubes (pre-dried and weighed), and then centrifuged at 1,000 g for 5 min. After all supernatants including frost layers were removed, the centrifuge tubes were dried overnight to remove residual moisture. A calculation formula of the solubility is shown in the following formula (1):

Solubility=[W₀−(W_{t′}−Wₜ)]/W₀*100% (1)

Wₜ refers to the weight of a centrifuge tube, W₀ refers to the weight of a milk powder, and W_{t′} refers to the total amount of the centrifuge tubes after drying.

(4) Glass Transition Temperature (Tg)

A differential scanning calorimeter was used for measurement. 2-3 mg of a powder was weighed, added onto an aluminum plate, and then sealed. An empty aluminum pan was used as a reference. After being balanced at 0° C., a sample was heated from 0° C. to 100° C. at a rate of 5° C./min, then cooled to 0° C. at a rate of 10° C./min, and finally heated from 0° C. to 100° C. at a rate of 5° C./min again.

### Example 1

A formula milk powder containing maltopentaose trehalose instead of maltodextrin includes the following raw materials in parts by mass: 86 parts of fresh milk, 2 parts of maltopentaose trehalose, 3 parts of corn oil, 2 parts of sunflower seed oil, 2 parts of soybean oil, 2 parts of a desalted whey powder, 2 parts of a concentrated whey protein powder, 0.8 parts of lactose, 0.1 parts of a multivitamin, and 0.1 parts of a complex mineral.

The multivitamin includes the components of a vitamin A, a vitamin C, a vitamin D, a vitamin E, a vitamin B1, a vitamin B2, a vitamin B6, a vitamin B12, a vitamin K1, folic acid, and pantothenic acid at a mass ratio of 1:5:0.002:32:5:25:18:0.001:0.008:3:10.

The complex mineral includes the components of calcium carbonate, potassium chloride, magnesium chloride, zinc sulfate, and ferric pyrosulfate at a mass ratio of 1:1.5:10:1.8:2.

A method for preparing the formula milk powder containing maltopentaose trehalose instead of maltodextrin includes the following steps:

(1) adding the maltopentaose trehalose, the desalted whey powder, the concentrated whey protein powder, and the lactose to the fresh milk for stirring at 50° C. and 300 rpm until complete dissolution, adding the corn oil, the sunflower seed oil, and the soybean oil for high-speed shearing homogenization at 3,000 rpm for 2 min, and then removing an insoluble substance through two layers of gauze to obtain a mixed solution;

(2) subjecting the mixed solution obtained in step (1) to high-pressure homogenization at 15 MPa and 30° C. for 6 min to obtain a mixed solution after high-pressure homogenization;

(3) concentrating the mixed solution obtained in step (2) to a solid content of 50%, and conducting spray drying at an inlet air temperature of 160° C. and an outlet air temperature of 90° C. to obtain a powdery base powder; and

(4) adding the multivitamin and the complex mineral to the powdery base powder obtained in step (3) for uniform mixing to obtain the formula milk powder.

### Comparative Example 1

The maltopentaose trehalose in Example 1 is changed into maltodextrin, other conditions are the same as those in Example 1, and a formula milk powder is obtained.

### Comparative Example 2

The maltopentaose trehalose in Example 1 is changed into a mixture of maltopentaose trehalose and maltodextrin at a mass ratio of 1:1, other conditions are the same as those in Example 1, and a formula milk powder is obtained.

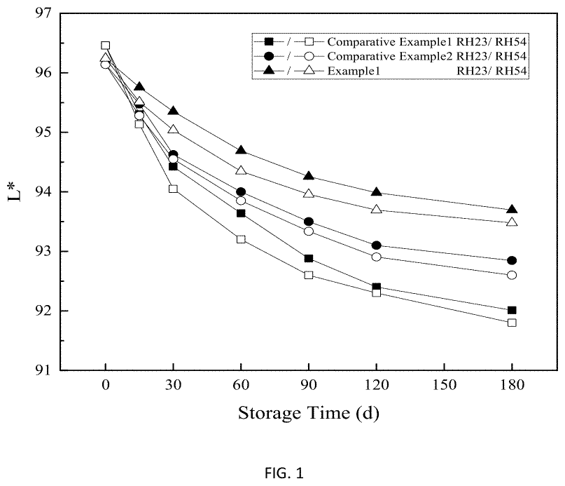

Results of changes in the color, surface morphology, solubility, and glass transition temperature of the formula milk powders in Example 1 and Comparative Examples 1 and 2 under different storage conditions are shown in FIG. 1 to FIG. 5, and Table 1.

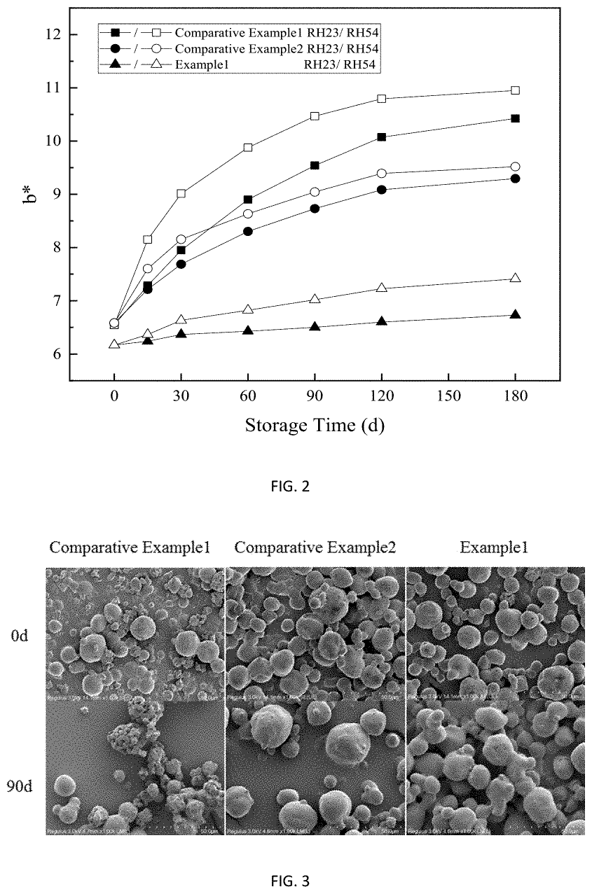

Based on changes in the color of the milk powders at different storage times, the stability of the milk powders is reflected to a large extent. FIG. 1, FIG. 2, and Table 1 show changes of the L* value and b* value at different storage times in Example 1 and Comparative Examples 1 and 2. From FIG. 1, FIG. 2, and Table 1, it can be seen that when the time is prolonged, the L* value of a milk powder is constantly decreased at different humidity values, and the b* value is gradually increased. Moreover, the change rate of the milk powder containing the maltopentaose trehalose is always lower than that of the milk powder containing the maltodextrin. In addition, based on the increase of the b* value in Comparative Examples 1 and 2, it is also indicated that a Maillard browning reaction is induced during storage, so that the color of the milk powder is darkened.

TABLE 1
Changes of the L* value and b* value at different storage times in
Example 1 and Comparative Examples 1 and 2

| | | | Comparative | Comparative |
|---|---|---|---|---|
| Index | | Example 1 | Example 1 | Example 2 |
| L* | 30 d | 95.35 | 94.42 | 94.62 |
| (23% RH) | 90 d | 94.26 | 92.88 | 93.50 |
| | 180 d | 93.69 | 92.01 | 92.85 |
| b* | 30 d | 6.37 | 7.95 | 7.69 |
| (23% RH) | 90 d | 6.50 | 9.54 | 8.73 |
| | 180 d | 6.73 | 10.42 | 9.29 |

FIG. 3 shows the surface morphology after storage at 23% RH for 90 days in Example 1 and Comparative Examples 1 and 2. From FIG. 3, it can be seen that the formula milk powders in Example 1 and Comparative Examples 1 and 2 are basically in a smooth spherical shape. However, after storage at 23% RH for 90 days, it is found that the milk powder in Comparative Example 1 has irregular morphology, while the milk powders in Example 1 and Comparative Example 2 are basically remained unchanged.

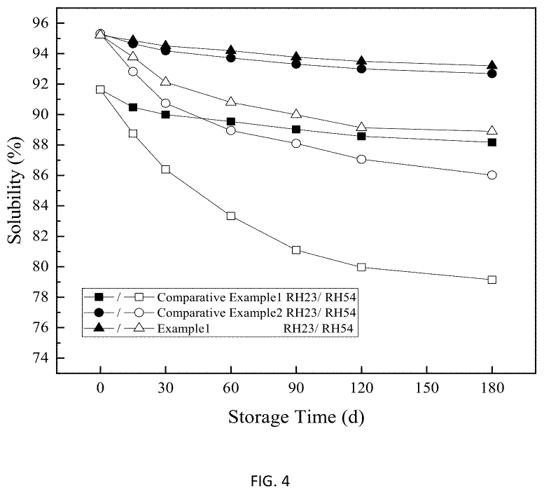

The solubility is a key property in evaluation of a milk powder. FIG. 4 and Table 2 show the solubility at different storage times in Example 1 and Comparative Examples 1 and 2. From FIG. 4 and Table 2, it can be seen that the solubility of powder bodies of the formula milk powders at 23% RH is basically unchanged. However, Comparative Example 1 still has significant differences with the other two examples, especially the solubility at 54% RH in Comparative Example 1 is reduced more rapidly.

TABLE 2
Test results of the solubility in Example 1 and Comparative
Examples 1 and 2

| | | | Comparative | Comparative |
|---|---|---|---|---|
| Index | | Example 1 | Example 1 | Example 2 |
| Solubility | 30 d | 92.12% | 86.38% | 90.74% |
| (54% RH) | 90 d | 89.98% | 81.09% | 88.09% |
| | 180 d | 88.89% | 79.14% | 86.02% |

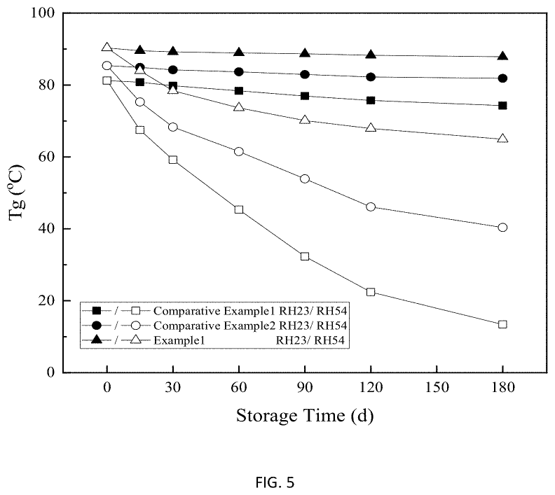

FIG. 5 and Table 3 show the glass transition temperature at different storage times in Example 1 and Comparative Examples 1 and 2. From FIG. 5 and Table 3, it can be seen that under the two storage conditions, the glass transition temperature (Tg) is determined by the content of the maltopentaose trehalose in the formula milk powders, and that is to say, the glass transition temperature in Example 1 is increasingly greater than that in Comparative Example 2 and Comparative Example 1. In a low-Tg powder, crystallization of lactose is likely to be induced, so that undesirable phenomena such as adhesion, agglomeration, accelerated Maillard reaction, and reduced solubility are caused. Therefore, the stability of the formula milk powder is greatly improved by adding the maltopentaose trehalose.

TABLE 3
Test results of the glass transition temperature in Example 1 and
Comparative Examples 1 and 2

| | | | Comparative | Comparative |
|---|---|---|---|---|
| Index | | Example 1 | Example 1 | Example 2 |
| Tg | 30 d | 78.42° C. | 59.21° C. | 68.31° C. |
| (54% RH) | 90 d | 70.13° C. | 32.31° C. | 53.91° C. |
| | 180 d | 64.93° C. | 13.42° C. | 40.38° C. |

### Comparative Example 3

The maltopentaose trehalose in Example 1 is changed into 2-10 parts of maltodextrin, other conditions are the same as those in Example 1, and a formula milk powder is obtained.

Properties of the obtained milk powder are tested, and test results are shown in Table 4.

From Table 4, it can be seen that after storage for 180 days, the effect of adding only 2 parts of the maltopentaose trehalosein can be achieved by adding 10 parts of the maltodextrin.

TABLE 4
Properties of formula milk powders stored at 22° C. and 54% RH
for 180 days

| Maltodextrin in | | | Surface | Solubility | Tg |
|---|---|---|---|---|---|
| parts by weight | L* | b* | morphology | (%) | (° C.) |
| 2 parts | 91.73 | 11.84 | Irregular shape | 79.14 | 13.42 |
| (Comparative | | | | | |
| Example 1) | | | | | |
| 4 parts | 92.05 | 10.52 | Spherical shape | 82.29 | 25.95 |
| | | | appeared | | |
| 6 parts | 92.61 | 9.24 | Partially | 84.98 | 35.74 |
| | | | irregular shape | | |
| 8 parts | 92.89 | 8.58 | Basically all | 87.14 | 47.13 |
| | | | spherical shape | | |
| 10 parts | 93.27 | 7.05 | Smooth | 90.15 | 59.84 |
| | | | spherical shape | | |

### Example 2

A formula milk powder containing maltopentaose trehalose instead of maltodextrin includes the following raw materials in parts by mass: 90 parts of fresh milk, 1.5 parts of maltopentaose trehalose, 2 parts of rapeseed oil, 1 part of sunflower seed oil, 2 parts of coconut oil, 1 part of a desalted whey powder, 1.5 parts of a concentrated whey protein powder, 0.8 parts of lactose, 0.1 parts of a multivitamin, and 0.1 parts of a complex mineral.

The multivitamin includes the components of a vitamin A, a vitamin C, a vitamin D, a vitamin E, a vitamin B1, a vitamin B2, a vitamin B6, a vitamin B12, a vitamin K1, folic acid, and pantothenic acid at a mass ratio of 1:3:0.004:31:6:27:18:0.002:0.008:4:10.

The complex mineral includes the components of calcium carbonate, potassium chloride, magnesium chloride, zinc sulfate, and ferric pyrosulfate at a mass ratio of 1:2:12:1.6:3.

With reference to the patent CN 111304270 A, a method for preparing the maltopentaose trehalose specifically includes the following steps:

adding β-cyclodextrin to water to obtain a cyclodextrin solution with a concentration of 20 g/L; adding 2 U/g_{cyclodextrin} of a cyclodextrin degrading enzyme and 50 U/g_{cyclodextrin} of a maltooligosaccharide trehalose synthetase to the cyclodextrin solution for a reaction at 45° C. and a pH of 7 for 40 min to obtain a maltodextrin-containing reaction solution; subjecting the reaction solution to enzyme deactivation (by boiling for 10 min) and decolorization (with activated carbon); using a chromatography column with a specification of 1.6 cm*100 cm, where Na-type cation exchange resin is filled to 65% of a height of the chromatography column; collecting a solution with a purity of greater than 95% at a temperature of 55° C., a loading volume of 5 mL, and a flow rate of 0.6 mL/min; and then conducting freeze-drying at −60° C. for 24 h to obtain the maltopentaose trehalose (non-reducing maltodextrin).

A method for preparing the formula milk powder containing maltopentaose trehalose instead of maltodextrin includes the following steps:

(1) adding the maltopentaose trehalose, the desalted whey powder, the concentrated whey protein powder, and the lactose to the fresh milk for stirring at 50° C. and 500 rpm until complete dissolution, adding the rapeseed oil, the sunflower seed oil, and the coconut oil for high-speed shearing homogenization at 4,000 rpm for 1.5 min, and then removing an insoluble substance through two layers of gauze to obtain a mixed solution;

(2) subjecting the mixed solution obtained in step (1) to high-pressure homogenization at 20 MPa and 35° C. for 8 min to obtain a mixed solution after high-pressure homogenization;

(3) concentrating the mixed solution obtained in step (2) to a solid content of 55%, and conducting spray drying at an inlet air temperature of 180° C. and an outlet air temperature of 90° C. to obtain a powdery base powder; and

(4) adding the multivitamin and the complex mineral to the powdery base powder obtained in step (3) for uniform mixing to obtain the formula milk powder.

After the obtained formula milk powder is stored at 22° C. and a relative humidity of 54% RH for 180 days, the L* value and the b* value are still maintained at 93.43 and 7.27. The milk powder has great surface morphology, which is not significantly changed in comparison with that on day 0. The milk powder has a solubility of 89.16% in water. It is tested that the milk powder has a glass transition temperature of 65.78° C., and certain thermal stability is achieved.

### Example 3

A formula milk powder containing maltopentaose trehalose instead of maltodextrin includes the following raw materials in parts by mass: 88 parts of fresh milk, 1.5 parts of maltopentaose trehalose, 3 parts of palm oil, 1 part of soybean oil, 2 parts of coconut oil, 1.6 parts of a desalted whey powder, 2 parts of a concentrated whey protein powder, 0.8 parts of lactose, 0.05 part of a multivitamin, and 0.05 part of a complex mineral.

The multivitamin includes the components of a vitamin A, a vitamin C, a vitamin D, a vitamin E, a vitamin B1, a vitamin B2, a vitamin B6, a vitamin B12, a vitamin K1, folic acid, and pantothenic acid at a mass ratio of 1:4:0.003:32:8:25:20:0.001:0.01:5:10.

The complex mineral includes the components of calcium carbonate, potassium chloride, magnesium chloride, zinc sulfate, and ferric pyrosulfate at a mass ratio of 1:1.6:11:2:4.

With reference to the patent CN 111304270 A, a method for preparing the maltopentaose trehalose specifically includes the following steps:

adding β-cyclodextrin to water to obtain a cyclodextrin solution with a concentration of 30 g/L; adding 4 U/g_{cyclodextrin} of a cyclodextrin degrading enzyme and 50 U/g_{cyclodextrin} of a maltooligosaccharide trehalose synthetase to the cyclodextrin solution for a reaction at 55° C. and a pH of 6.5 for 20 min to obtain a maltodextrin-containing reaction solution; subjecting the reaction solution to enzyme deactivation (by boiling for 10 min) and decolorization (with activated carbon); using a chromatography column with a specification of 1.6 cm*100 cm, where Na-type cation exchange resin is filled to 60% of a height of the chromatography column; collecting a solution with a purity of greater than 95% at a temperature of 60° C., a loading volume of 8 mL, and a flow rate of 0.8 mL/min; and then conducting freeze-drying at −60° C. for 24 h to obtain the maltopentaose trehalose (non-reducing maltodextrin).

A method for preparing the formula milk powder containing maltopentaose trehalose instead of maltodextrin includes the following steps:

(1) adding the maltopentaose trehalose, the desalted whey powder, the concentrated whey protein powder, and the lactose to the fresh milk for stirring at 50° C. and 400 rpm until complete dissolution, adding the palm oil, the soybean oil, and the coconut oil for high-speed shearing homogenization at 5,000 rpm for 1 min, and then removing an insoluble substance through two layers of gauze to obtain a mixed solution;

(2) subjecting the mixed solution obtained in step (1) to high-pressure homogenization at 20 MPa and 35° C. for 5 min to obtain a mixed solution after high-pressure homogenization;

(3) concentrating the mixed solution obtained in step (2) to a solid content of 50%, and conducting spray drying at an inlet air temperature of 180° C. and an outlet air temperature of 85° C. to obtain a powdery base powder; and

(4) adding the multivitamin and the complex mineral to the powdery base powder obtained in step (3) for uniform mixing to obtain the formula milk powder.

After the obtained formula milk powder is stored at 22° C. and a relative humidity of 54% RH for 180 days, the L* value and the b* value are still maintained at 93.79 and 7.33. The milk powder has great surface morphology, which is in a smooth spherical shape. The milk powder has a solubility of 90.18% in water, a glass transition temperature of 63.25° C., and great thermal stability.

What is claimed is:

1. A formula milk powder containing maltopentaose trehalose instead of maltodextrin, comprising the following raw materials in parts by mass: 85-90 parts of fresh milk, 1-2 parts of maltopentaose trehalose, 5-10 parts of vegetable oil, 1-2 parts of a desalted whey powder, 1.5-3 parts of a concentrated whey protein powder, 0.5-0.8 parts of lactose, 0.05-0.1 parts of a multivitamin, and 0.05-0.1 parts of a complex mineral.

2. The formula milk powder containing maltopentaose trehalose instead of maltodextrin according to claim 1, wherein the maltopentaose trehalose is obtained by hydrolyzing β-cyclodextrin as a substrate with a cyclodextrin degrading enzyme into maltoheptaose, converting an α-1,4-glycosidic bond into an α-1,1-glycosidic bond with a maltose trehalose synthetase, and then conducting refining.

3. The formula milk powder containing maltopentaose trehalose instead of maltodextrin according to claim 2, wherein the refining comprises subjecting a product obtained after an enzymatic conversion reaction to enzyme deactivation, decolorization, and separation and purification through Na-type cation exchange resin, collecting a solution with a purity of greater than 95%, and then conducting freeze-drying.

4. The formula milk powder containing maltopentaose trehalose instead of maltodextrin according to claim 3, wherein during the separation and purification, a chromatography column with a specification of 1.6 cm*100 cm is used, the resin is filled to 60%-70% of a height of the chromatography column, and the solution is collected at a temperature of 55-60° C., a loading volume of 5-10 mL, and a flow rate of 0.5-0.8 mL/min.

5. The formula milk powder containing maltopentaose trehalose instead of maltodextrin according to claim 1, wherein a method for preparing the maltopentaose trehalose comprises the following steps:
adding β-cyclodextrin to water or a buffer solution to obtain a cyclodextrin solution with a concentration of 10-30 g/L; then, adding a cyclodextrin degrading enzyme and a maltooligosaccharide trehalose synthetase to the cyclodextrin at an amount of 0.5-5 U/g_{cyclodextrin} and 10-100 U/g_{cyclodextrin} respectively for a reaction at a temperature of 25-65° C. and a pH of 5.0-8.5 for 20-40 min to obtain a maltodextrin-containing reaction solution; and finally, refining the maltodextrin-containing reaction solution to obtain the maltopentaose trehalose.

6. The formula milk powder containing maltopentaose trehalose instead of maltodextrin according to claim 1, wherein the vegetable oil comprises one or more of corn oil, palm oil, sunflower seed oil, soybean oil, rapeseed oil, and coconut oil.

7. The formula milk powder containing maltopentaose trehalose instead of maltodextrin according to claim 1, wherein the multivitamin comprises the components of a vitamin A, a vitamin C, a vitamin D, a vitamin E, a vitamin B1, a vitamin B2, a vitamin B6, a vitamin B12, a vitamin K1, folic acid, and pantothenic acid at a mass ratio of 1:(3-5):(0.002-0.005):(30-32):(5-8):(25-27):(18-20):(0.001-0.002):(0.008-0.01):(1-5):(10-12).

8. The formula milk powder containing maltopentaose trehalose instead of maltodextrin according to claim 1, wherein the complex mineral comprises the components of calcium carbonate, potassium chloride, magnesium chloride, zinc sulfate, and ferric pyrosulfate at a mass ratio of 1:(1-2):(10-15):(1.6-2):(2-4).

9. A method for preparing the formula milk powder according to claim 1, comprising the following steps:
(1) adding the maltopentaose trehalose, the desalted whey powder, the concentrated whey protein powder, and the lactose to the fresh milk for dissolution, adding the vegetable oil for high-speed shearing homogenization, and then conducting filtration to obtain a mixed solution;
(2) subjecting the mixed solution obtained in step (1) to high-pressure homogenization at 15-20 MPa to obtain a mixed solution after high-pressure homogenization;
(3) concentrating the mixed solution obtained in step (2) to a solid content of 50%-55%, and conducting spray drying to obtain a powdery base powder; and
(4) adding the multivitamin and the complex mineral to the powdery base powder obtained in step (3) for uniform mixing to obtain the formula milk powder.

10. The method according to claim 9, wherein in step (3), the spray drying is conducted at an inlet air temperature of 160-180° C. and an outlet air temperature of 85-90° C.

11. The method according to claim 9, wherein in step (2), the high-pressure homogenization is conducted at a temperature of 30-40° C. for 5-8 min.

12. The method according to claim 9, wherein in step (1), the dissolution is conducted by stirring at 40-50° C. and 300-500 rpm until complete dissolution.

13. The method according to claim 9, wherein in step (1), the high-speed shearing homogenization is conducted at a shearing speed of 3,000-5,000 rpm for 1-2 min.

14. The method according to claim 9, wherein in step (1), the filtration is conducted to remove an insoluble substance through two layers of gauze.
